(19) United States
(12) Patent Application Publication
(10) Pub. No.: US 2006/0292197 A1
(43) Pub. Date: Dec. 28, 2006

(54) Manufactured articles comprising a pest-combating composition

(76) Inventors: John P. Bennett, Durham, NC (US); Thomas M. Strzemienski, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/474,251

(22) Filed: Jun. 22, 2006

Related U.S. Application Data
(60) Provisional application No. 60/692,993, filed on Jun. 22, 2005.

(51) Int. Cl. A01N 65/00; A01N 25/00

(52) U.S. Cl. 424/405; 424/755; 424/760

(57) ABSTRACT

An article including a pest-combating composition applied to or incorporated in such article, wherein the pest-combating composition includes capsicum and/or a cruciferous agent selected from among mustard and horseradish, as active ingredients of the composition. The active ingredients may be micro-encapsulated or otherwise formulated for application to the manufactured article for subsequent pest-combating activity. The pest-combating compositions are active in the dry state, and are useful in application to containers for storage and transport of foodstuffs, as well as in other applications in which an article having the pest-combating composition applied thereto would otherwise be susceptible to degradation, destruction or other adverse effect from pest species, e.g., insects and rodents.

### REFERENCE TO RELATED APPLICATION

The subject matter of the present application relates to and encompasses the disclosure of U.S. Provisional Patent Application No. 60/692,993, filed on Jun. 22, 2005 in the names of Thomas M. Strzemienski and John P. Bennett for “MANUFACTURED ARTICLES COMPRISING A PEST-COMBATING COMPOSITION.” The disclosure of such provisional application is hereby incorporated herein by reference in its entirety, for all purposes.

### BACKGROUND OF THE INVENTION

1. Field of the Invention

The present invention relates to articles including a pest-combating composition and to methods of making and using such articles.

2. Description of the Related Art

Many manufactured articles are variously susceptible to the ravages of a wide variety of pests, which act to degrade, destroy or otherwise compromise the character or utility of such articles for their intended use.

Such articles may be of widely varying type, including for example packaging articles for storage and transport of foodstuffs or other contents that are susceptible to predations of pest species, building structures that are susceptible to infestation by pest species, apparel articles that are subject to destruction by insects and other pest species, and fabric, web and sheet-form materials that are subject to attack by pests.

The pest species to which such manufactured articles are susceptible, include insects, arachnids, and other arthropods, rodents, reptiles and other animal pests, molds, algae, and microbial pathogens such as bacteria and viruses.

It would be a significant advance in the art to provide these manufactured articles with the capability to combat pests that are deleterious to such articles.

### SUMMARY OF THE INVENTION

The present invention relates to articles including a pest-combating composition and to methods of making and using such articles.

The invention relates in one aspect to an article including a pest-combating composition applied to or incorporated in such article, wherein the pest-combating composition comprises capsicum and/or a cruciferous agent selected from the group consisting of mustard and horseradish.

The article can be of any suitable type, e.g., a manufactured article, such as a container, shipping pallet, paper bag or other cellulosic article, building component (such as insulation, a prefabricated structural assembly, etc.), or a material, component or ingredient.

In another aspect, the invention relates to a packaging article comprising a corrugated board box, wherein the box includes corrugated board comprising spaced-apart sheets of linerboard defining an intersheet volume between them containing a corrugated fluting member with a pest-combating composition being present in said box, said pest-combating composition, including capsicum and/or a cruciferous agent selected from the group consisting of mustard and horseradish.

Yet another aspect of the invention relates to method of imparting pest-combating character to an article, comprising applying to said article a pest-combatingly effective amount of a composition comprising capsicum and/or a cruciferous agent selected from the group consisting of mustard and horseradish.

As used herein, the term “pest-combating” refers to pesticidal or pest-repellent action of the compositions of the invention.

Other aspects, features and embodiments of the invention will be more fully apparent from the ensuing disclosure and appended claims.

### BRIEF DESCRIPTION OF THE DRAWINGS

FIG. 1 is a sectional elevation view of a corrugated paperboard article incorporating a pest-combating composition in accordance with the present invention, in one embodiment thereof.

FIG. 2 is a perspective view of a food package formed of corrugated paperboard incorporating a pest-combating composition, in accordance with a specific embodiment of the invention.

FIG. 3 is a sectional elevation view of a structural wall assembly of the building, in which insulation includes a pest-combating composition in accordance with the present invention, in another embodiment thereof.

FIG. 4 is a sectional elevation view of a fibrous web laminate incorporating a pest-combating composition in accordance with the invention, in a still further embodiment thereof.

### DETAILED DESCRIPTION OF THE INVENTION, AND PREFERRED EMBODIMENTS THEREOF

The present invention relates to manufactured articles including a pest-combating composition and to methods of making and using such articles, and reflects the discovery of pest-combating compositions that are efficacious in dry (non-aqueous and non-moisture-containing) media, that are biocompatible, and that are biodegradable.

The disclosures of the following U.S. patents are hereby incorporated by reference herein, for all purposes: U.S. Pat. No. 6,534,078 issued Mar. 18, 2003 to Thomas M. Strzemienski, et al. for “Micro-Encapsulated Pepper-Mustard Composition and Methods of Using the Same;” and U.S. Pat. No. 5,626,945 issued May 6, 1997 to Arnold L. Berzins, et al. for “Repulpable, Water Repellent Paperboard.”

The pest-combating compositions of the invention contain capsicum and/or a cruciferous agent such as mustard or horse radish, in amounts (and, when both capsicum and cruciferous agents are present together, in relative proportions to one another) that confer pest-combating effectiveness to the composition. Preferably, both capsicum and cruciferous agent are concurrently present in the composition.

The composition may contain the capsicum and/or cruciferous active ingredients in an encapsulated or micro-encapsulated form, or otherwise as constituents in a porous matrix material, e.g., in finely divided form, in which the active ingredients can co-act to combat pests in the manufactured goods in which the composition is deployed.

Examples of porous matrix material which may be useful as a support or carrier for the active ingredients include wood pulp, clays and mineralic materials in particulate form, in which the active ingredients are impregnated or otherwise coated.

One particularly preferred composition of the invention entails a micro-encapsulated pepper and/or mustard composition, e.g., a pepper-mustard composition. The micro-encapsulated pepper and/or mustard composition comprises an emulsified pepper and/or mustard mixture combined with one or more surfactants and a water base. The surfactant or surfactants form encapsulations that surround and contain small micron and submicron size particles of the active components, pepper and/or mustard.

Pepper in the form of a liquid extract can be used in the composition. Various grades of pepper based on heat qualities are available commercially. Pepper utilized in a preferred composition can be extracted from fruit of pepper plants such as jalapeno, birdseye, cayenne or habanero. Although various heat grades, e.g., heat grades of 1,000 to 1 million Scoville heat units, may be used in specific pest-combating composition of the invention, heat grades of 1,000 to 160,000 Scoville heat units are preferred in some formulations.

In various compositions of the invention, mustard is employed as the active cruciferous agent, and can be utilized in purified liquid extract form.

In other compositions of the invention, horseradish can be employed as the active cruciferous agent, as extracted from horseradish plants.

The active ingredients of the compositions of the invention can be utilized in pure form, as food grade extracts.

When pepper and/or mustard form the active ingredients of the composition, it is preferred that such ingredients are naturally occurring, as taken from pepper and/or mustard plants, respectively. However, it is appreciated that synthetic versions of pepper and/or mustard can be usefully employed. Accordingly, as used herein, the terms pepper and mustard are intended to be broadly construed to include not only naturally occurring pepper and mustard, but any and all synthetic or artificial versions of pepper and mustard.

In addition to pepper and/or the cruciferous agent, mustard or horseradish, compositions of the invention in specific embodiments include surfactant(s), water and other solvents. Other solvents may be of any suitable type, as effective to yield a composition of desired pest-combating efficacy. In specific embodiments, citrus oil, sometimes referred to as d-limonene, is utilized as an acceptable solvent. The solvent provides a suitable medium for mixing or combining the active ingredients, e.g., pepper and mustard, or alternatively pepper and horseradish, with one another.

In one preferred composition of the invention, a micro-encapsulated pepper-mustard composition is employed, in which pepper constitutes approximately 0.4-1.0 wt % of the composition, based on the total weight of the composition, and mustard constitutes approximately 0.3-0.8 wt % of the composition, based on the total weight of the composition. The surfactant(s) in such composition are present at a concentration of approximately 0.2-0.6 wt %, based on the total weight of the composition, and the solvent utilized for combining pepper and mustard in the composition is present therein at a concentration of approximately 0.2-0.4 wt %, based on the total weight of the composition. Water may be present in such composition, at a concentration of approximately 90-99 wt %, based on the total weight of the composition.

In some embodiments, the weight percentages for the respective components of the composition differ from the above-described ranges. For example, in some compositions of the invention, pepper may be present at a concentration of approximately 0.1-0.8 wt %, based on the total weight of the composition, and/or mustard may be present at a concentration of approximately 0.1-1.2 wt %, based on the total weight of the composition. The solvent or the surfactant(s) may in some compositions be present at a concentration of approximately 0.1-1.0 wt %, based on the total weight of the total composition. Water in some compositions may be present at a concentration of approximately 90-99 wt %, based on total weight of the composition.

In various embodiments of the invention, a micro-encapsulated pepper-mustard composition is formulated with one or more surfactants. In one preferred composition, two different surfactants such as block copolymers of propylene oxide and ethylene oxide and polyoxyethylene sorbitan monolaurate are used, however, in other compositions, one, two, three or more surfactants can be utilized. Suitable surfactants for micro-encapsulated pepper-mustard compositions of the present invention include derivatives of capryl imidzoline, alkyl polyglycol ethers, polyoxyalkylene lanolins, block copolymers of propylene oxide and ethylene oxide, polyoxyethylene sorbitan monolaurate, sodium lauryl sulfate, and the like.

In the manufacture of the composition, the surfactant(s) are dispersed in the water base. Surfactants that are particularly suitable for the practice of the invention include a hydrophilic end group and a hydrophobic hydrocarbon tail. The hydrophilic group has an affinity for water while the hydrophobic tail has an aversion for water. Above a certain concentration, the surfactant molecules tend to associate with one another in a group whereby the hydrophilic group is exposed to the water and yields a configuration in which the molecules form a generally circular or spherical arrangement, while the hydrophobic tails extend inwardly and associate with each other, e.g., in an intertwined relationship.

By this action, micellular clusters are formed, whereby the active ingredients of the composition, e.g., pepper and/or mustard, are encapsulated within the resulting micelles.

After the surfactant or surfactants have been dispersed in the water base, the active ingredients, e.g., pepper and mustard, are added. In order to achieve encapsulation, the pepper and mustard mixture is emulsified to facilitate transport of the active ingredients into the micelles in which the size of the pepper-mustard encapsulations is on the order of 0.1-10 microns. To effect micro-encapsulation of the particles of pepper and mustard active ingredients, an energetic emulsion process is employed, such as can be achieved by use of a high speed, high energy mixing operation, e.g., use of a sonication apparatus or an ultrasonic high-energy probe. Emulsification agents and adjuvants can also be used to effectuate the micro-encapsulation of the active ingredients of the composition.

In various pepper-mustard compositions of the invention, the individual or combined concentration of the pepper and mustard active ingredients can be in a range of from about 1,000-8,000 parts-per-million (ppm) by weight, based on total weight of the composition, although it will be appreciated that the combined concentration as well as the relative proportions of the active ingredients may be widely varied in the practice of the invention, to provide pest-combating capability of an appropriate character for a specific end use application of the composition.

Pepper-horseradish compositions of the invention may be similarly formulated.

As a further variation, compositions of the invention can be applied directly to the manufactured goods to which it is desired to impart pest-combating character. The composition can be applied as a liquid suspension containing the active ingredients, or the active ingredients may be combined in or coated on a matrix material, e.g., in the form of dry particles that are contained in a packet or sachet that is incorporated in the manufactured goods, such as in a compartment of a package or housing.

As a still further alternative, the manufactured goods or other articles may be dip coated in a liquid suspension of the composition, or the composition may be sprayed onto or otherwise applied to the manufactured goods or other articles, such as in an aerosol composition of pepper, and mustard or horseradish, components, involving a concentration of the active ingredients of approximately 1,000 to 12,000 ppm by weight, based on total weight of the composition.

The invention thus contemplates the application to manufactured goods or incorporation in manufactured goods of a composition including pepper and/or cruciferous active ingredients. The composition may be applied in a “wet” or liquid suspension or aerosol form which then is subsequently dried to form a film, coating or deposit of the active material, or the active ingredients may be incorporated in the manufactured goods in a powder or other solid form, in the first instance.

When applied in a wet liquid suspension or aerosol form, the applied material may be dried under ambient conditions, or alternatively, the goods may be subjected to forced-air drying or elevated temperature conditions to effectuate deposition or incorporation of the active ingredients in an effective dry form. For example, a packaging article, structural assembly, or other manufactured goods may pass on a fabrication line through an application unit in which the composition of the invention is applied to the goods, and during which the goods pass through a dryer unit or oven, to yield the active ingredients in such goods in an effective form and amount, as a residue, film, coating, deposit or other form of the active material. In some instances of application, the concentration of active ingredients can advantageously be in a range of from about 1,000 to about 10,000 ppm by weight, based on the total dry weight of the composition, although it will be recognized that the specific amount of the active ingredients can be widely varied in the general practice of the invention.

The compositions of the present invention thus differ from those of the prior art in that the compositions of the invention are applied to manufactured articles and utilized in a dried or dry form with such articles for sustained pest-combating action. Although pepper-mustard compositions have heretofore been known, for example as described in Strzemienski et al. U.S. Pat. No. 6,534,078, the use of such compositions for pest-combating service has been confined to wet utilization (e.g., involving “objects that are exposed to water and moisture” as described at column 5, lines 36-37 of the Strzemienski '078 patent) in aquatic, marine, and soil environments. Such compositions have therefore not been contemplated for use in the manner of the present invention.

The pest species to which such manufactured articles have conferred pest-combating character by application or incorporation of the compositions of the invention, include insects, arachnids, and other arthropods, rodents, reptiles and other animal pests, molds, algae, and microbial pathogens such as bacteria and viruses.

The amounts and concentrations of the active capsicum and/or cruciferous agents in the compositions of the invention that are pest-combatingly effective for specific pests are readily determinable within the skill of the art based on the disclosure herein, by simple empirical determinations of cidal or repellent effect involving the pest species of interest.

The articles or materials to which the compositions of the present invention are applicable can be of any suitable type, including, for example and without limitation, packaging articles for storage and transport of foodstuffs, consumer goods or other contents that are susceptible td predations of pest species, building structures that are susceptible to infestation by pest species, apparel articles that are subject to destruction by insects and other pest species, fabric, web and sheet-form materials that are subject to attack by pests, etc.

Referring now to the drawings, FIG. 1 is a sectional elevation view of a corrugated paperboard article 10 incorporating a pest-combating composition in accordance with the present invention, in one embodiment thereof.

The corrugated board article 10, as illustrated, is of a double-face construction including an inner linerboard 16, an outer linerboard 12 supported in substantially parallel, spaced-apart relation by a corrugated medium or fluting 14. The board article 10 is suitable for the production of shipping containers, e.g., for shipment and storage of frozen meat, fruit, vegetables, ice-packed poultry, grains, granular food products, and the like. The linerboards 12 and 16 include interior facing surfaces to which are adhesively secured the tips or crests of the corrugated medium or fluting 14, utilizing adhesives such as an FDA approved starch-based adhesive.

Coated on the upper surface of the fluting 14 in the view shown in FIG. 1 is a film 20 including the pest-combating composition of the invention, such as a pepper-mustard formulation in a suitable carrier or vehicle medium. The carrier or vehicle medium may for example be a cellulosic gum, a waterproof, e.g., wax, coating, or other material appropriate to the specific usage of the board 10. For example, when the board 10 is utilized to form a container for foodstuffs, the coating may be a wax-based composition of the type disclosed in U.S. Pat. No. 5,626,945 issued May 6, 1997 to Arnold L. Berzins, et al. for “Repulpable, Water Repellent Paperboard,” in which the coating medium is formulated to contain the pest-combating composition of the present invention.

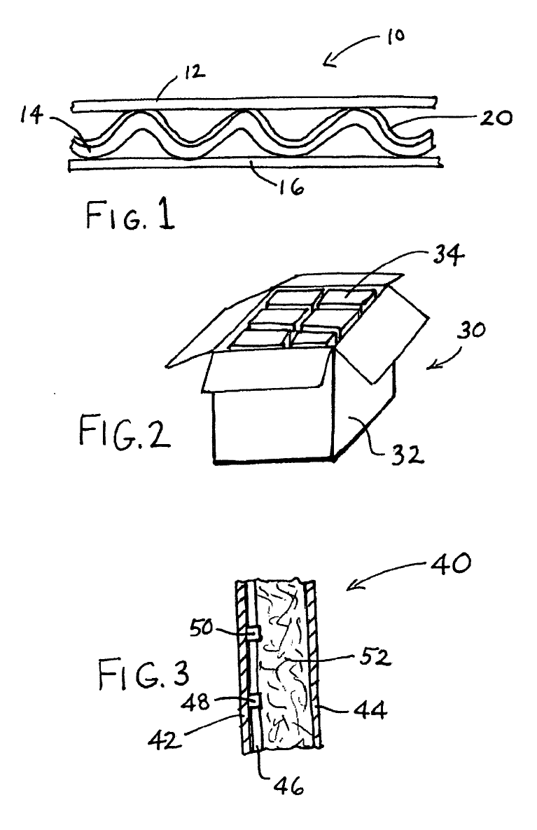

FIG. 2 is a perspective view of a food package 30 including a container 32 formed of corrugated paperboard incorporating a pest-combating composition, e.g., a corrugated paperboard manufactured as described in connection with FIG. 1. The container 32 as shown holds a plurality of boxes 34, which may contain foodstuffs, such as produce, cereals, meats, or the like.

FIG. 3 is a sectional elevation view of a structural wall assembly 40 of a building, which may be manufactured as a pre-fabricated panel including spaced-apart wall members 42 and 44, with an electrical conduit or wireway 46 secured to wall number 42 by connector straps 48 and 50. Interposed between the wall members 42 and 44 is insulation 52, which includes a pest-combating composition in accordance with the present invention.

The insulation 52 may be of a fibrous bat type, in which fibers of the insulated medium are coated or impregnated with a pest-combating composition containing pepper and/or mustard, or pepper and/or horseradish, components.

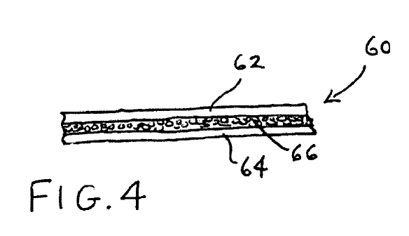

FIG. 4 is a sectional elevation view of a fibrous web laminate 60 incorporating a pest-combating composition in accordance with the invention. The fibrous web laminate 60 includes a first fibrous web 62, a second fibrous web 64, and a layer 66 of granules of the pest-combating composition of the invention therebetween.

The fibrous web laminate 60 may be utilized as material for fabrication of apparel articles, or sporting goods such as tents, sleeping bags, pack frames, etc. The laminate can be formed out of fibrous web layers 62 and 64 that are sufficiently tightly woven or bound, so that the granular pest-combating composition is retained in position in the laminate. Alternatively, the fibrous web layers may be provided on their inner facing surfaces with a backing, e.g., of a mesh or fabric material to assist in retention of the pest-combating composition in the laminate. Additionally, the layers 62 and 64 may be quilted or otherwise sewn or interconnected to facilitate positional fixation of the pest-combating composition material.

As a still further alternative, the pest-combating composition may be incorporated in a matrix material or film, or other support, in which the pest-combating composition is effective for its intended purpose.

As yet another alternative, the pest-combating composition may be incorporated in a sizing or other treatment formulation, which is applied to one or both of the fibrous web layers and then dried to leave a deposited film or residue on and or within such a layer(s) to provide sustained pest-combating action.

It will therefore be appreciated that the pest-combating compositions of the invention may be applied to or incorporated in a wide variety of manufactured articles, to impart pest-combating character thereto. Due to the biocompatibility, biodegradability, safety and efficacy of the pest-combating compositions of the invention, such compositions enable products to be fabricated that resist degradation, attack and destruction by pest species, and that enable the manufactured articles, including such compositions to be utilized in contact with humans and animals, and in packaging of foodstuffs, beverages, etc., without adverse effect.

Although the pest-combating compositions of the invention have been described herein with particular reference to manufactured articles and materials, it will be appreciated that the pest-combating compositions can likewise be used in connection with non-manufactured articles and non-manufactured materials that are susceptible to adverse effects of pests against which the pest-combating compositions of the invention are pest-combatingly effective.

The features and advantages of the invention are more fully shown by the following example, which is intended to be illustrative only, and not in any way limiting of the invention or its characteristics, utility or applicability.

### EXAMPLE I

The pest-combating efficacy of compositions of the invention was assessed against wild Norway rats (Rattus norvegicus). Wild Norway rats are commensal rodents that frequent domestic domiciles and storage areas, often causing contamination of human food supplies, and thereby increasing the loss of human food stores. The rats employed in the testing included equal numbers of male and female rats. All animals used in the experiment were held for a period of 7 days prior to use in the test, with temperature, humidity and lighting being provided in accordance with the Guide for the Care and Use of Laboratory Animals (Regional Resource Counsel 1996). After the acclimation period, feed (Fresh Purina Rodent Diet 5001) was placed in a feed cup stabilized with a wood plate (having dimensions of 12 inches×12 inches) and placed in an untreated box in the center of the test arena. The test arena was an oval-shaped stock tank with a volume of 20.56 cubic feet (2 feet×4 feet×2 feet). The test animals were provided with clean food and water in each arena.

During the pre-conditioning period, the untreated box placed in the center of the arena had a hole in its side to allow constrained access to the interior of the box and the feed therein. After approximately 3-7 days of permitting the rats to gnaw on the box opening to enlarge it, the box was replaced with another untreated box with a smaller opening that did not allow access to food, but required additional gnawing. These methods were repeated until a sufficient number of the population of test animals was observed to gnaw on boxes to access food.

The pre-conditioning box then was replaced with a single untreated box and a single treated box, so that each rat was exposed to a control and a treatment box. Each box had an identical-sized small hole to promote gnawing to gain access to food held within the box. Gnawing activity was measured according to the increase in size of the entry hole. The exposure period was 14 days, with replacement of the boxes in each arena daily to avoid circumstances in which the hole was large enough to allow a rat access, to constrain the rat to testing of whether the treated box would limit access to the rat. Accordingly, both boxes were replaced if one and/or both of the boxes were gnawed open. Position of the boxes was switched to limit any positional bias when new boxes were replaced.

Gnawing of the control and treatment boxes was measured with a planimeter. Each section of a box that was gnawed upon and through was copied directly to paper, with the opening of the box translated to a blackened area on the copy paper, and with the blackened area being measured by the planimeter. A hole saw was initially used to make holes in the cardboard, to use the open area measurement of such hole as a basis for additional surface determination of gnawing.

The following formula was used to determine efficacy of the test composition:
% efficacy=(control activity−treatment activity)/(control activity)×100.

HPLC analysis of the corrugated board used in the boxes showed that the board was characterized by an average of 14,000 Schoville heat units. The test composition was capsicum, as applied to the test boxes at a concentration providing the aforementioned average Schoville heat unit value.

Ten treated boxes and ten control boxes were subjected to rat exposure over the test period of fourteen days, and were graded once daily on a scale of 0 (=no rat gnawing observed on the box), 1 (=some rat gnawing observed on the box) or 2 (=rat gnawed hole was observed that was large enough for rat ingress to the interior volume of the box). The results are shown in Table 1 below, and efficacy, determined according to the above-noted formula, is set out below in “Results.”

TABLE 1
Performance Evaluation of Pepper Treated Boxes

| Day | Day | Day | Day | Day | Day | Day | Day | Day | | | | | |
|---|---|---|---|---|---|---|---|---|---|---|---|---|---|
| 1 | 2 | 3 | 4 | 5 | 6 | 7 | 8 | 9 | Day 10 | Day 11 | Day 12 | Day 13 | Day 14 |

Treated Boxes

| | | | | | | | | | | | | | | |
|---|---|---|---|---|---|---|---|---|---|---|---|---|---|---|
| #1 | 1 | 1 | 0 | 0 | 0 | 0 | 0 | 0 | 0 | 0 | 0 | 0 | 0 | 0 |
| #2 | 0 | 0 | 0 | 0 | 0 | 0 | 0 | 0 | 0 | 0 | 0 | 0 | 0 | 0 |
| #3 | 2 | 2 | 0 | 1 | 1 | 0 | 0 | 0 | 0 | 0 | 0 | 0 | 0 | 0 |
| #4 | 1 | 1 | 0 | 0 | 0 | 0 | 0 | 1 | 1 | 0 | 0 | 0 | 0 | 0 |
| #5 | 1 | 1 | 2 | 2 | 2 | 0 | 0 | 2 | 2 | 0 | 0 | 0 | 0 | 0 |
| #6 | 2 | 2 | 2 | 2 | 2 | 2 | 2 | 0 | 0 | 0 | 0 | 0 | 0 | 2 |
| #7 | 0 | 0 | 2 | 2 | 2 | 2 | 2 | 0 | 0 | 2 | 2 | 2 | 2 | 2 |
| #8 | 0 | 0 | 0 | 0 | 0 | 0 | 0 | 1 | 1 | 0 | 0 | 0 | 0 | 0 |
| #9 | 0 | 0 | 0 | 0 | 0 | 2 | 2 | 2 | 2 | 0 | 0 | 0 | 2 | 2 |
| #10 | 0 | 0 | 0 | 0 | 0 | 2 | 2 | 0 | 0 | 0 | 0 | 0 | 2 | 2 |

Control Boxes

| | | | | | | | | | | | | | | |
|---|---|---|---|---|---|---|---|---|---|---|---|---|---|---|
| #1 | 2 | 2 | 2 | 2 | 2 | 2 | 2 | 2 | 2 | 2 | 2 | 2 | 2 | 2 |
| #2 | 2 | 2 | 2 | 2 | 2 | 2 | 2 | 2 | 2 | 2 | 2 | 2 | 2 | 2 |
| #3 | 1 | 1 | 2 | 2 | 2 | 2 | 2 | 2 | 2 | 2 | 2 | 2 | 2 | 2 |
| #4 | 2 | 2 | 2 | 2 | 2 | 2 | 2 | 2 | 2 | 2 | 2 | 2 | 2 | 2 |
| #5 | 2 | 2 | 0 | 0 | 0 | 2 | 2 | 2 | 2 | 2 | 2 | 2 | 2 | 2 |
| #6 | 0 | 0 | 0 | 0 | 0 | 0 | 2 | 2 | 2 | 2 | 2 | 2 | 2 | 2 |
| #7 | 2 | 2 | 0 | 0 | 1 | 1 | 0 | 2 | 2 | 0 | 0 | 0 | 0 | 0 |
| #8 | 2 | 2 | 2 | 2 | 2 | 2 | 2 | 2 | 2 | 2 | 2 | 2 | 2 | 2 |
| #9 | 2 | 2 | 2 | 2 | 2 | 1 | 1 | 0 | 0 | 2 | 2 | 2 | 0 | 1 |
| #10 | 2 | 2 | 2 | 2 | 2 | 0 | 0 | 2 | 2 | 2 | 2 | 2 | 0 | 0 |

0 = no gnawing observed
1 = some gnawing observed
2 = rat can fit through the gnawed hole
RESULTS
Pepper-treated boxes: 105 data points for repellency and 35 data points for gnawing. Efficacy was 75%.
Control boxes: 31 data points for repellency and 109 data points for entering the box. Efficacy was 22%.

The foregoing results therefore evidence the utility of compositions of the invention for providing enhanced protection of articles against pest attacks.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. An article including a pest-combating composition applied to or incorporated in such article, wherein the pest-combating composition comprises capsicum and/or a cruciferous agent selected from the group consisting of mustard and horseradish.

2. An article according to claim 1, wherein the cruciferous agent comprises mustard.

3. An article according to claim 1, wherein the cruciferous agent comprises horseradish.

4. An article according to claim 1, wherein the capsicum and/or cruciferous agent are in an encapsulated or micro-encapsulated form.

5. An article according to claim 1, wherein the capsicum and/or cruciferous agent are in a porous matrix material in said article.

6. An article according to claim 5, wherein the porous matrix material comprises a material selected from the group consisting of wood pulp, clays and mineralic materials.

7. An article according to claim 6, wherein the capsicum and/or cruciferous agent are impregnated in or coated on the porous matrix material.

8. An article according to claim 1, wherein the capsicum and/or cruciferous agent are in a finely divided form in said article.

9. An article according to claim 1, wherein the pest-combating opposition comprises a micro-encapsulated pepper and/or mustard composition.

10. An article according to claim 9, wherein said micro-encapsulated pepper and/or mustard composition comprises an emulsified pepper and/or mustard mixture combined with one or more surfactants and a water base.

11. An article according to claim 10, wherein pepper and/or mustard are present in said composition in particles of micron or submicron size.

12. An article according to claim 1, wherein the capsicum is extracted from a plant selected from the group consisting of jalapeno, birdseye, cayenne and habanero.

13. An article according to claim 1, wherein the capsicum has a heat grade in a range of from 1,000 to 1 million Schoville heat units.

14. An article according to claim 1, wherein the cruciferous agent comprises mustard in a purified liquid extract form.

15. An article according to claim 1, wherein the cruciferous agent comprises horseradish in a purified liquid extract form.

16. An article according to claim 1, wherein the capsicum and/or cruciferous agent in the pest-combating composition are present therein as food grade extracts.

17. An article according to claim 1, wherein the capsicum comprises a non-naturally occurring pepper material.

18. An article according to claim 1, wherein the cruciferous agent comprises a non-naturally occurring mustard material.

19. An article according to claim 1, wherein the pest-combating composition further comprises at least one surfactant.

20. An article according to claim 19, wherein the pest-combating composition further comprises water.

21. An article according to claim 19, wherein the pest-combating composition further comprises a solvent other than water.

22. An according to claim 21, wherein said solvent other than water comprises d-limonene.

23. An article according to claim 1, wherein the pest-combating composition comprises a micro-encapsulated pepper-mustard composition including pepper at a concentration of 0.4-1.0 wt %, mustard at a concentration of 0.3-0.8 wt %, surfactant(s) at a concentration of 0.2-0.6 wt %, a solvent other than water, at a concentration of 0.2-0.4 wt %, and water at a concentration of 90-99 wt %, wherein all weight percentages are based on total weight of the composition, and the weight percentages of all ingredients of the composition total to 100 weight percent.

24. An article according to claim 1, wherein the pest-combating composition comprises a pepper at a concentration of 0.1-0.8 wt % and/or mustard at a concentration of 0.1-1.2 wt %, surfactant(s) and solvent(s) other than water at a concentration of 0.1-1.0 wt %, and water at a concentration of 90-99 wt %, wherein all weight percentages are based on total weight of the composition, and the weight percentages of all ingredients of the composition total to 100 weight percent.

25. An article according to claim 1, wherein the pest-combating composition comprises at least one surfactant selected from the group consisting of block copolymers of propylene oxide and ethylene oxide, polyoxyethylene sorbitan monolaurate, sodium lauryl sulfate, capryl imidzoline, alkyl polyglycol ethers, and polyoxyalkylene lanolins.

26. An article according to claim 1, wherein capsicum and/or the cruciferous agent are encapsulated within micelles.

27. An article according to claim 1, wherein the combined concentration of the capsicum and cruciferous agent is in a range of from about 1,000 to about 8,000 ppm by weight, based on total weight of the composition.

28. An article according to claim 1, wherein the pest-combating composition is present on a surface of the article.

29. An article according to claim 1, wherein the pest-combating composition is incorporated in the article.

30. An article according to claim 1, wherein the pest-combating composition is impregnated in the article.

31. An article according to claim 1, wherein the pest-combating composition is present in the article in a dry form.

32. An article according to claim 1, wherein the pest-combating composition is pest-combatingly effective for a pest selected from the group consisting of arthropods, rodents, reptiles, other animal pests, molds, algae, and microbial pathogens.

33. An article according to claim 32, wherein the pest-combating composition is pest-combatingly effective for insects.

34. An article according to claim 32, wherein the pest-combating composition is pest-combatingly effective for rodents.

35. An article according to claim 32, wherein the pest-combating composition is pest-combatingly effective for a pest selected from the group consisting of molds and algae.

36. An article according to claim 32, wherein the pest-combating composition is pest-combatingly effective for a pest selected from the group consisting of bacteria and viruses.

37. An article according to claim 1, wherein the pest-combating composition is active as a pesticide.

38. An article according to claim 1, wherein the pest-combating composition is active as a pest repellent.

39. An article according to claim 1, wherein the article comprises a packaging article.

40. An article according to claim 39, wherein said packaging article is adapted for storage and transport of foodstuffs, consumer goods or other contents susceptible to predations of pest species.

41. An article according to claim 1, wherein the article comprises a building structure.

42. An article according to claim 41, wherein the building structure comprises a pre-fabricated building panel.

43. An article according to claim 42, wherein said pre-fabricated building panel comprises insulation having said pest-combating composition associated therewith.

44. An article according to claim 43, wherein said insulation comprises a fibrous material, and said pest-combating composition is coated on and/or impregnated in fibers of said fibrous material.

45. An article according to claim 1, wherein the article comprises an apparel article.

46. An article according to claim 45, wherein the pest-combating composition is present in a powder or granular form.

47. An article according to claim 45, wherein the apparel item comprises a fibrous material, and the pest-combating composition is coated on and/or impregnated in fibers of said fibrous material.

48. An article according to claim 1, wherein the article comprises a fabric, web or sheet-form material.

49. A package article comprising a corrugated board box, wherein the box includes corrugated board comprising spaced-apart sheets of linerboard defining an intersheet volume therebetween containing a corrugated fluting member, with a pest-combating composition being present in said box, said pest-combating composition including capsicum and/or a cruciferous agent selected from the group consisting of mustard and horseradish.

50. A package article according to claim 49, wherein said pest-combating composition comprises a pepper-mustard composition.

51. A package article according to claim 49, wherein said pest-combating composition is present in a dry form in said intersheet volume.

52. A package article according to claim 49, wherein said corrugated fluting member is adhesively secured to each of the spaced-apart sheets of linerboard by an adhesive formulation, and wherein said pest-combating composition is present in said adhesive formulation.

53. A package article according to claim 49, wherein the pest-combating composition is coated on a surface in the intersheet volume.

54. A package article according to claim 49, wherein the pest-combating composition is present in a carrier medium.

55. A package article according to claim 54, wherein the carrier medium comprises a cellulosic gum.

56. A package article according to claim 54, wherein the carrier medium comprises a waterproof coating on a surface of the corrugated box.

57. A package article according to claim 49, wherein the pest-combating composition comprises a micro-encapsulated pepper-mustard composition.

58. A method of imparting pest-combating character to an article, comprising applying to said article a pest-combatingly effective amount of a composition comprising capsicum and/or a cruciferous agent selected from the group consisting of mustard and horseradish.

59. A method according to claim 58, wherein the composition comprises a pepper-mustard composition.

60. A method according to claim 58, wherein the composition is formed by a process including micro-encapsulation of the capsicum and/or cruciferous agent.

61. A method according to claim 60, wherein said process includes emulsification of the capsicum and/or cruciferous agent.

62. A method according to claim 61, wherein said emulsification is carried out by sonication or use of an ultrasonic high-energy probe.

63. A method according to claim 58, wherein the pest-combating composition is applied to the article as a liquid composition, followed by drying of the composition.

64. A method according to claim 58, wherein the pest-combating composition is applied to the article in the form of dry particles.

65. A method according to claim 58, wherein the pest-combating composition is applied to the article by dip coating the article in a liquid suspension of the composition.

66. A method according to claim 58, wherein the pest-combating composition is applied to the article by spray application.

67. A method according to claim 58, wherein the pest-combating composition is applied to the article to provide an individual or combined concentration of active ingredients thereof in a range of from 1,000 to 8,000 ppm by weight, based on total dry weight of the composition.

68. The article of claim 1, comprising a shipping pallet or paper bag.

69. The article of claim 1, comprising a cellulosic article.
